(19) United States
(12) Patent Application Publication
(10) Pub. No.: US 2013/0155457 A1
(43) Pub. Date: Jun. 20, 2013

(54) IMAGE FORMING APPARATUS, IMAGE FORMING METHOD, AND COMPUTER-READABLE MEDIUM

(71) Applicant: Canon Kabushiki Kaisha, Tokyo (JP)

(72) Inventor: Shigeo Miura, Tokyo (JP)

(73) Assignee: CANON KABUSHIKI KAISHA, Tokyo (JP)

(21) Appl. No.: 13/715,875

(22) Filed: Dec. 14, 2012

(30) Foreign Application Priority Data
Dec. 19, 2011 (JP) 2011-277325

(51) Int. Cl. G06F 3/12

(52) U.S. Cl. CPC G06F 3/1296
USPC 358/1.15

(57) ABSTRACT

An image forming apparatus provided with an image memory includes a printing unit configured to print data, a determining unit configured to determine whether data of all pages of the print data can be stored in the image memory as reprint data, a storage unit configured to store data of a first page to an N-th page of the print data into the image memory in a case where the determining unit determines that the data of the all pages of the print data cannot be entirely stored in the image memory as the reprint data, an accepting unit configured to accept a reprint start instruction, and a receiving unit configured to receive a remaining data of an N+1-th page to a final page of the print data, wherein the printing unit prints the stored data and the receiving unit receives the remaining data to be printed.

### BACKGROUND OF THE INVENTION

1. Field of the Invention

The present invention relates to an image forming apparatus, an image forming method, and a computer-readable medium.

2. Description of the Related Art

In recent years, an image forming apparatus (hereinafter referred to as a “printer”) configured to develop an image described in a description language by, for example, a personal computer (PC) or a mobile terminal, and form the image using a low-capacity memory of about 32 megabytes has been generally in widespread use.

On the other hand, the printer has a reprint function that works in the following manner. A host computer first transmits data to the printer, and the printer stores that data after printing one copy among a plurality of copies according to the data. Then, after that, when the printer detects a key operation performed for printing of the printer or detects a print instruction issued from the host side, the printer prints remaining copies among the plurality of copies.

This reprint function is constituted by the following operations.

1. The host computer transmits print data to the printer.
2. The printer prints the print data.
3. The printer stores the print data therein.
4. The printer prints the same data when the printer detects a reprint instruction issued from the printer or the host computer.

The printer prints a plurality of copies in a case where the printer detects an instruction to print a plurality of copies. This reprint function allows a user to first print one copy of a print product according to the print data, and print the remaining copies after confirming whether a desired print product can be acquired, thereby preventing beforehand the printer from printing a plurality of copies of a print product which the user is unsatisfied with.

Further, it is possible to reduce an occupied space of a memory by providing a function of storing only the last print data piece among print data pieces according to a plurality of print jobs to allow only that print data piece to be reprinted, and deleting print data pieces other than the print data piece of the last print job.

In this case, there is raised such a problem that a printer equipped with only a low-capacity memory may be unable to entirely accommodate even the print data piece of the last print job in the image memory, and therefore unable to store the remaining data, leading to an inability to reprint the data. Japanese Patent Application Laid-Open No. 11-105381 discusses a method for reprinting data by re-transmitting data for reprinting from a host computer to a printer.

However, the method re-transmitting the reprint data has a disadvantage of an increase in a first print out time (FPOT; a time from issuance of a print instruction to an output of a first sheet of an instructed print product) of an reprint operation, compared to the method storing reprint data in a memory of a printer.

More specifically, according to the technique discussed in Japanese Patent Application Laid-Open No. 11-105381, the host computer monitors a re-transmission request from the printer, and the host computer re-transmits the data according to the re-transmission request. Therefore, it takes a longer time until the printer starts reprinting the data, whereby the reprinting productivity cannot be sufficiently high.

Further, the conventional reprint function has such a problem that a user may forget to use the reprint function when printing a plurality of copies, and end up printing a plurality of wasteful copies.

### SUMMARY OF THE INVENTION

According to an aspect of the present invention, the present invention is directed to an image forming method that includes printing print data, storing divided data corresponding to a part of the print data into an image memory in a case where the print data cannot be entirely stored in the image memory, accepting a reprint start instruction, printing the stored divided data by a printing unit according to the reprint start instruction, and receiving remaining print data subsequent to the stored divided data to print it.

According to another aspect of the present invention, the present invention is directed to an image forming method that includes printing one copy of print data to which printing of a plurality of copies is set, storing the print data into an image memory, accepting a reprint start instruction, and printing remaining copies among the plurality of copies using the print data stored by the storing according to the reprint start instruction.

According to the exemplary embodiments of the present invention, it is possible to realize high-speed reprint processing even when print data cannot be stored entirely.

Further, it is possible to bring about an effect of saving a time to re-transmit entire data from a host upon detection of a reprint instruction, and improving the FPOT of reprint processing. Further, it is possible to prevent a user from printing a plurality of wasteful copies.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a printing system according to an exemplary embodiment of the present invention.

FIG. 2 is a flowchart illustrating an example of an operation of a host side in the printing system according to an exemplary embodiment of the present invention.

FIG. 3 (3A+3B) is a flowchart illustrating an example of an operation of a printer side in the printing system according to an exemplary embodiment of the present invention.

FIG. 4 is a flowchart illustrating an example of an operation of the host side that stores undivided reprint data into a server.

FIG. 5 is a flowchart illustrating an example of an operation of the host side that stores undivided reprint data into a host memory.

FIG. 6 (6A+6B) is a flowchart illustrating an example of an operation of the printer that receives the undivided data from a server or host Uniform Resource Identifier (URI).

FIG. 7 is a flowchart illustrating an example of an operation of the host side that stores divided data into the server.

FIG. 8 is a flowchart illustrating an example of an operation of the host side that stores divided data into the memory in the host.

FIG. 9 (9A+9B) is a flowchart illustrating an example of an operation of the printer that receives the divided data from the server or host URI.

FIG. 10 is a flowchart illustrating an example of an operation of the host that allocates a memory resource of the host or the server in a case where print data cannot be entirely stored in a print memory.

FIG. 11 is a flowchart illustrating an example of an operation of the host that allocates a memory resource of the host or the server in a case where print data cannot be entirely stored in the print memory.

FIG. 12 is a flowchart illustrating an example of an operation of the host that notifies the printer of a URI, according to which the printer acquires print data and reprint data from the URI.

FIG. 13 is a flowchart illustrating an example of an operation of the printer that can change a setting of a predetermined time according to an instruction from a user.

FIG. 14 is a flowchart illustrating an example of an operation of the host side that automatically sets a reprint (trial) mode in a case where printing of a plurality of copies is specified at the host side.

FIG. 15 is a flowchart illustrating an example of an operation of the host side that sets the reprint (trial) mode in a case where printing of a plurality of copies is specified at the host side and a toner saving mode or an energy saving mode of the printer is specified at the host or the printer.

FIG. 16 illustrates an example of a procedure for reprinting data according to Internet Printing Protocol (IPP).

FIG. 17 illustrates how the host transmits a print job to the printer according to Extensible Markup Language Paper Specification (XPS).

FIG. 18 illustrates how the printer receives print data from the server URI using a print thicket according to XPS.

FIG. 19 is a flowchart illustrating a tenth exemplary embodiment.

### DESCRIPTION OF THE EMBODIMENTS

Various exemplary embodiments, features, and aspects of the invention will be described in detail below with reference to the drawings.

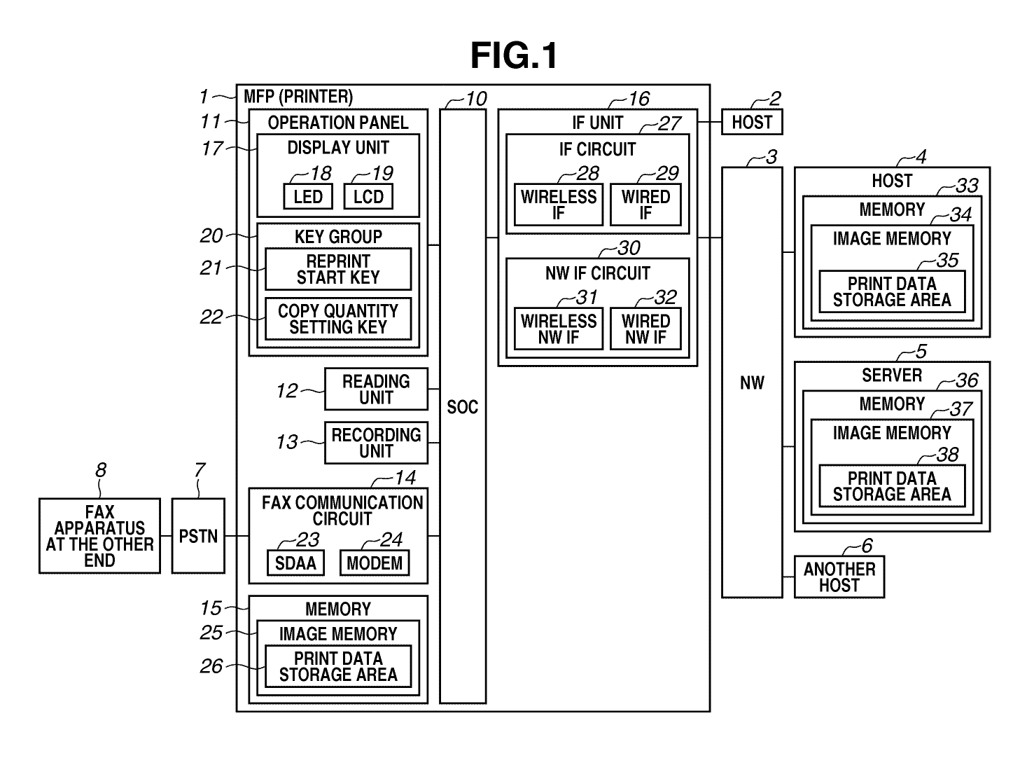

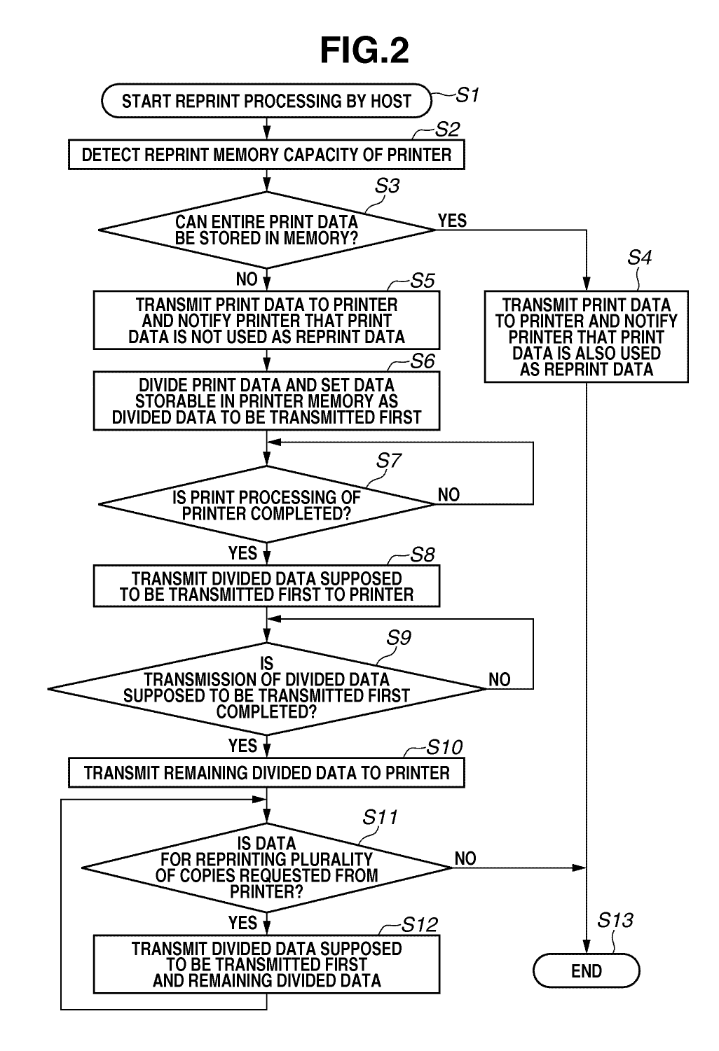

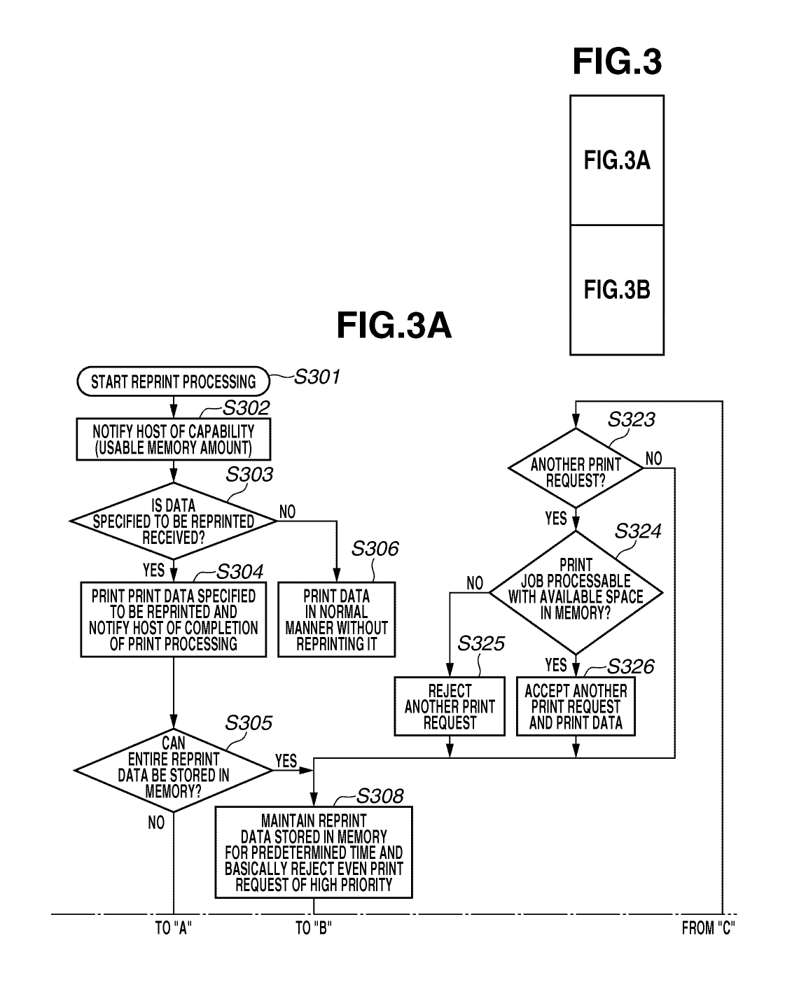

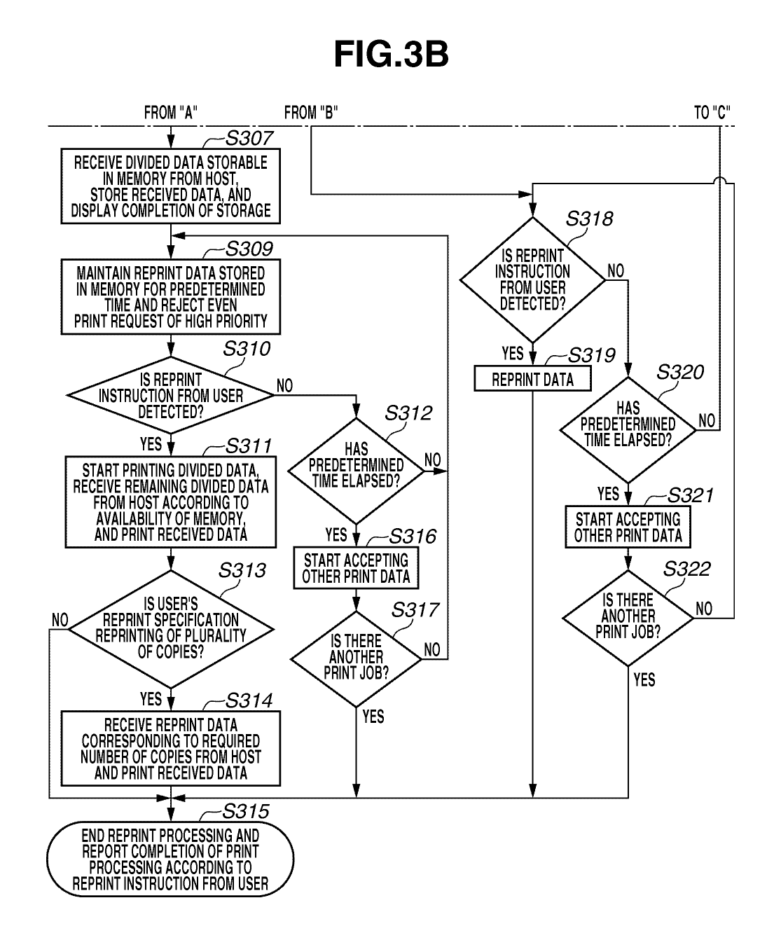

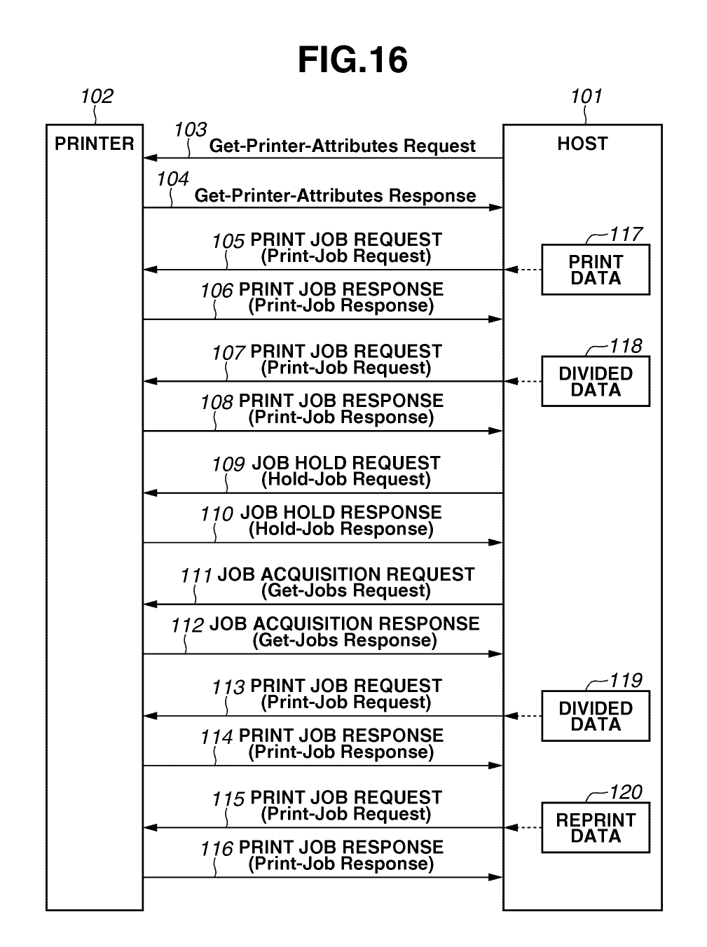

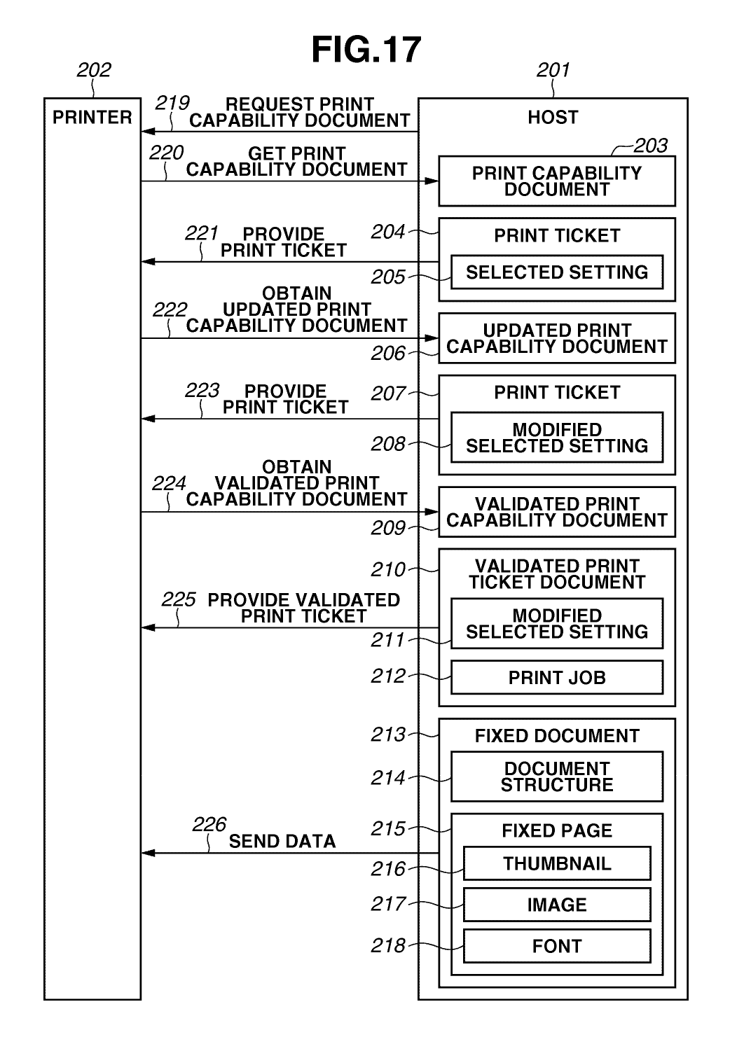

A printing system configured as illustrated in FIG. 1 operates as indicated by the flowcharts illustrated in FIGS. 2 and 3. A processing procedure of a host (computer) and a printer is performed according to a procedure of an Internet Printing Protocol (IPP) method illustrated in FIG. 16 or a Print Ticket method illustrated in FIG. 17.

FIG. 1 discloses a printing system including a printer 1 that can store a received print job, and hosts 2 and 4. The printing system illustrated in FIG. 1 realizes processing that will be described below.

When print data can be entirely stored in an image memory 25 of the printer 1, this print data can be reprinted. On the other hand, when print data cannot be entirely stored in the image memory 25, for reprinting, the print data is divided into data amounts each storable in the image memory 25, and is transmitted from the host to the printer 1 (without receiving a reprint start instruction).

Then, in step S309, the printer 1 stores the received divided print data into the image memory 25. After that, in step S310, the printer 1 receives a reprint start instruction from the printer 1, the host 2, or the host 4. Then, the printer 1 prints the stored divided print data, and receives the remaining divided print data subsequent to the divided print data from the host 2 or 4, thereby performing reprint processing.

The first exemplary embodiment is characterized in that, in a case where print data cannot be entirely stored in the image memory 25, divided print data, which is a part of the print data, is stored in the image memory 25 without receiving a reprint start instruction. As a result, the divided print data can be immediately printed upon reception of an instruction of a reprint start key, thereby speeding up the FPOT.

Further, since the remaining print data subsequent to the divided print data is also sequentially received and printed, thereby smoothly realizing reprint processing.

FIG. 1 is a block diagram illustrating a configuration of the printing system. The printing system includes the printer 1. The printer 1 may be a multi function peripheral (MFP) having a printing function. The host computer (hereinafter referred to as the “host”) 2 instructs the printer 1 to carry out a print job. The host 2 is embodied by, for example, a PC or a mobile terminal. The printer 1 and the host 2 are connected to each other via a wired interface (IF) such as a universal serial bus (USB) or a wireless IF such as Bluetooth (registered trademark).

A network (NW) 3 is embodied by, for example, a local area network (LAN) or a wide area network (WAN). A host 4 is connected to the printer 1 and a server 5 via the NW 3. The host 4 is embodied by, for example, a PC or a mobile terminal in a similar manner to the host 2. The server 5 is connected to the printer 1 and the host 4 via the NW 3.

Another host 6 is connected to the printer 1 via the NW 3. The host 6 is embodied by, for example, a PC or a mobile terminal in a similar manner to the hosts 1 and 2. A network 7 is a public switched telephone network (PSTN). A facsimile (FAX) apparatus 8 at the other end is connected to the printer 1 via the PSTN 7.

A System on Chip (SoC) 10 controls the entire system of the printer 1. An operation panel 11 provides a display for notifying a user of the printer 1 about a state of the apparatus, and determines an operation of the printer 1 based on an instruction from the user.

A reading unit 12 reads a document, and acquires data to be transmitted to, for example, the hosts 2 and 4, the another host 6, and the FAX apparatus 8 at the other end. The data read by the reading unit 12 can be printed by a recording unit 13.

A FAX communication circuit 14 enables FAX communication. A memory 15 stores a program for allowing the printer 1 to operate, management data of the printer 1, or image data to be transmitted, received, or printed. An IF unit 16 serves as an interface for a connection between the printer 1 and an external apparatus such as the host 2 and the NW 3.

A display unit 17 provides a display for notifying a user about a state of the printer 1. The display unit 17 includes a light emitting diode (LED) 18. The display unit 17 further includes a liquid crystal display (LCD) 19. A key group 20 is used when a user instructs the printer 1 to perform various kinds of processing.

The key group 20 includes a reprint start key 21. The key group 20 further includes a copy quantity setting key 22. The FAX communication circuit 14 includes a Silicon Data Access Arrangement (SDAA) 23, which is a semiconductor Network Control Unit (NCU).

A modem 24 is a modulator/demodulator for enabling FAX communication. The memory 15 includes an image memory 25. The image memory 25 can store print data to be printed according to a print job received from the host 2 or 4, the server 5, or the another host 6.

The image memory 25 includes an area 26 that can store print data to be printed. The IF unit 16 includes an IF circuit 27. The IF circuit 27 includes a wireless IF 28.

The IF circuit 27 further includes a wired IF 29. The IF unit 16 includes a network IF circuit 30. The network IF circuit 30 includes a wireless NWIF 31.

The network IF circuit 30 includes a wired NWIF 32. A memory 33 is a built-in memory of the host 4. The memory 33 includes an image memory 34. The image memory 34 includes a print data storage area 35.

A memory 36 is a built-in memory of the server 5. The memory 36 includes an image memory 37. The image memory 37 includes a print data storage area 38.

FIG. 2 is a flowchart illustrating an example of an operation of the host side of the printing system according to the present exemplary embodiment. A central processing unit (CPU) of the host 2 or 4 executes a program stored in a memory of the host 2 or the memory 33, thereby realizing the processing that will be described below. In the following description, the hosts 2 and 4 will be collectively referred to as the “host”.

In step S1, the host starts reprint processing. In step S2, the host detects a capacity of a reprint memory of the memory 15 of the printer 1. In step S3, the host determines whether print data can be entirely stored in the memory 15 of the printer 1 as reprint data.

In step S4, the host transmits the print data to the printer 1 and notifies the printer 1 that the print data is also used as reprint data. In step S5, the host transmits the print data to the printer 1 and notifies the printer 1 that the print data is not used as reprint data. In step S6, the host divides the print data and sets data storable in the memory 15 of the printer 1 as divided data supposed to be transmitted first.

The divided data supposed to be transmitted first includes the data of a first page to be printed first, in a case where the reprint data is data corresponding to a plurality of pages. In step S7, the host determines whether print processing of the printer 1 is completed on the print data transmitted in step S5. The host determines whether the print processing is completed based on information transmitted from the printer 1.

In step S8, the host transmits the divided data supposed to be transmitted first, which is divided in step S6, to the printer 1.

In step S9, the host determines whether the transmission of the first divided data to the printer 1 is completed. Then, in step S9, the host determines whether the host should transmit remaining divided data other than the divided data supposed to be transmitted first in the print data to the printer 1 according to an instruction of the reprint start key 219 of the first divided data at the printer 1.

In step S10, the host transmits the remaining divided data to the printer 1. This transmission is realized by sequentially transmitting the reprint data divided into appropriate data according to the capacity of the reprint memory. In step S11, the host determines whether data for reprinting a plurality of copies is requested from the printer 1.

In step S12, the host transmits print data for reprinting according to the data request in step S11. In step S13, the host ends the processing.

FIG. 3 (3A+3B) is a flowchart illustrating an example of an operation of the printer 1 of the printing system according to the present exemplary embodiment. The processing that will be described below is realized under control of the SoC 10. Further, the printer 1 works in cooperation with the hosts 2 and 4, and the another host 6, whereby the operation of the printer 1 is realized. In the following description, the hosts 2 and 4 and the another host 6 will be collectively referred to as the “host”.

This is an example of an operation of directly receiving the divided reprint data from the host in advance in a case where reprint data cannot be entirely stored in the memory 15 when the printer 1 prints print data received from the host.

In step S301, the printer 1 starts reprint processing. In step S302, the printer 1 notifies the host about the capability (the capacity of the reprint memory) of the printer 1. This notification is received by the host in step S2 illustrated in FIG. 2.

In step S303, the printer 1 determines whether the printer 1 has received print data instructed to be reprinted at the host. If the printer 1 has received print data specified to be reprinted at the host (YES in step S303), in step S304, the printer prints that print data. Then, the printer 1 notifies the host about completion of the printing after the printing.

In step S305, the printer 1 determines whether the print data can be entirely stored in the memory 15 of the printer 1 as reprint data.

If the printer 1 determines that the printer 1 has received normal print data that is not instructed to be reprinted at the host (NO in step S303), in step S306, the printer 1 prints this print data in a normal manner.

In step S307, the printer 1 receives divided data (reprint data) into which the print data is divided so as to be storable in the memory 15 from the host, stores the received divided data into the memory 15, and provides a display notifying a user that the divided data is stored. This display is provided on the display unit 17.

In step S308, the printer 1 maintains the reprint data stored in the memory 15 for a predetermined time, and does not accept another print request even if there is a print request of high priority.

In step S309, the printer 1 maintains the reprint data stored in the memory 15 for a predetermined time, and does not accept another print request even if there is a print request of high priority. These steps can prevent the reprint data in the memory 15 (the image memory 25) of the printer 1 from being overwritten and deleted when print processing is requested from the another host 6 before the user, who wants to reprint data, issues a reprint instruction. As a result, the reprint processing can be prioritized over the print processing from the another host 6.

In step S310, the printer 1 determines whether the user has operated the reprint start key 21, whereby the printer 1 has detected a reprint instruction.

In step S311, the printer 1 starts printing the divided data. Further, in step S311, the printer 1 receives the remaining divided data from the host according to the availability of the memory 15, and prints the received data. In step S312, the printer 1 determines whether a predetermined time has elapsed.

In step S313, the printer 1 determines whether the user's reprint specification is reprinting of a plurality of copies. In step S314, the printer 1 receives reprint data corresponding to the plurality of copies from the host, and prints the received data.

In step S315, after the reprint processing is completed, the printer 1 reports the completion of the printing according to the reprint instruction from the user. In step S316, the printer 1 starts accepting other print data since there is no reprint instruction using the reprint start key 21.

In step S317, the printer 1 determines whether there is another print job. In step S318, the printer 1 determines whether the printer 1 has detected an instruction from the user using the reprint start key 21. In step S319, the printer 1 performs reprint processing.

In step S320, the printer 1 determines whether a predetermined time has elapsed. In step S321, the printer 1 starts accepting other print data since there is no reprint instruction using the reprint start key 21. In step S322, the printer 1 determines whether there is another print job. In step S323, the printer 1 determines whether there is another print request.

In step S324, the printer 1 determines whether the print request is a print job processable within an available space of the memory 15. In step S325, the printer 1 rejects the other print request. If the printer 1 cannot hold reprint data while processing the other print request (NO in step S324), the other print request is rejected. In step S326, the printer 1 accepts the other print request and performs print processing.

According to step S324, the printer 1 may be able to carry out a print job from the another host 6 by efficiently using an available space of the memory 15 even while the reprint data is stored in the memory 15. In this case, the printer 1 can avoid keeping the print job from the another host 6 waiting.

FIG. 16 illustrates an example of a procedure of performing the reprint processing illustrated in FIGS. 2 and 3 according to the above-described IPP.

By process 103 to process 106, print data is transmitted from a host 101 to a printer 102. These processes correspond to steps S1 to S5 illustrated in FIG. 2. Further, these processes correspond to steps S301 to S303 illustrated in FIG. 3.

The host 101 detects an available area (a capacity of the reprint memory) of the memory 15 of the printer 102 by the “Get-Printer-Attributes Response” 104 or the print job response (“Print-Job Response”) 106. Alternatively, the host 101 may detect the availability of the memory 15 by a not-illustrated job validity confirmation operation (“Validate-Job Operation”).

If the host determines that reprint data cannot be entirely stored in the memory 15 according to the detection result of the capability of the reprint memory, the host 101 divides the reprint data and transmits the divided data to the printer 102 according to a print job request 107.

By a job hold request 109, the host 101 instructs the printer 102 to suspend the print job to stop printing the reprint data until a user issues an instruction using the reprint start key 21.

Alternatively, the job hold request 109 may be omitted, and instead the host 101 may notify the printer 102 that transmitted divided data 118 is reprint data by using the print job request 107. In this case, the printer 102 can recognize that the transmitted divided data 118 is reprint data, thereby suspending the print job until the user issues a reprint instruction. After that, upon issuance of a reprint instruction from the user, the printer 102 prints the first divided reprint data corresponding to the divided data 118.

In response to this reprint instruction, remaining divided data 119 other than the divided data 18 transmitted first is transmitted from the host 101 to the printer 102, and is printed by the printer 102. In a case where there is an instruction to reprint a plurality of sheets (copies) from the user via the copy quantity setting key 22, reprint data 120 corresponding to that number of sheets or copies is transmitted from the host 101 to the printer 102, and is printed by the printer 102.

This reprint data 120 is a combination of the divided data 118 and the divided data 119, and is data capable of realizing printing of the sheets or copies corresponding to the number specified via the copy quantity setting key 22. Therefore, the data of the reprint data 120 is repeatedly transmitted to the printer 102 according to the number of copies to be printed.

The host 101 illustrated in FIG. 16 corresponds to the hosts 2 and 4, and the another host 6 illustrated in FIG. 1. The printer 102 corresponds to the printer 1 illustrated in FIG. 1. The “Get-Printer-Attributes Request” 103 is procedural signal for requesting information such as the function and the capability of the printer 102 from the host 101.

The “Get-Printer-Attributes Response” 104 is a response for reporting the information such as the function and capacity of the printer 102 from the printer 102.

The print job request (“Print-Job Request”) 105 is a signal for requesting the printer 102 to print data. The print job response (“Print-Job Response”) 106 is a signal for reporting a printing state of the printer 102 from the printer 102 to the host 101 in response to the print job request (“Print-Job Request”) 105.

The print job request (“Print Job Request) 107 is a print job request for transmitting divided data for reprinting, and an operation of dividing reprint data into data storable in the memory of the printer 102 and transmitting the divided data to the printer 102 in advance.

A print job response (“Print-Job Response”) 108 is a response to the print job request (“Print-Job Request”) 107.

The job hold request (“Hold-Job Request”) 109 is a signal for requesting the printer 102 to temporarily hold the divided data for reprinting in the transmitted print job request (“Print-Job request”) 107 in the memory and suspend printing until detection of a user's instruction.

A job hold response (“Hold-Job Response”) 110 is a response signal transmitted from the printer 102 in response to the job hold request (“Hold-Job Request”) 109.

A job acquisition request (“Get-Jobs Request”) 111 is a signal for requesting the state in which the printer 102 carries out the job.

A job acquisition response (“Get-Jobs Response”) 112 is a response signal to the job acquisition request (“Get-Jobs Request”) 111.

The host 101 can recognize the state in which the printer 102 carries out the job by repeating exchanges of the job acquisition request (“Get-Jobs Request”) 111 and the job acquisition response (“Get-Jobs Response”) 112. A print job request (“Print-Job Request”) 113 is a request for printing the divided data 119, and this request realizes transmission of the divided data 119 to the printer 102 and printing of the divided data 119 by the printer 102.

A print job response (“Print-Job Response”) 114 is a response signal for transmitting a printing state of the divided data 119 to the host 101.

A print job request (“Print-Job Request”) 115 is a request for printing the reprint data 120, and this request realizes transmission of the reprint data 120 to the printer 102 and printing of the reprint data 120 by the printer 102.

A print job response (“Print-Job Response”) 116 is a response signal for transmitting a printing state of the reprint data 120 to the host 101.

Print data 117 is print data that the user specifies as data to reprint with a printer driver at the host 101, or print data specified as data to be automatically reprinted.

In a case where the printer driver is set as an initial setting in such a manner that all print data pieces to be printed by the printer 102 should be reprinted, each print data piece is automatically specified to be reprinted even if the user does not instruct the printer 102 to reprint the print data when instructing the printer 102 to print the print data.

The divided reprint data 118 is data including at least a first page in a case where the reprint data is data of, for example, 5 pages.

The divided reprint data 119 is data from a page next to the divided reprint data to a final page, and is data separately transmitted according to the capacity of the reprint memory of the memory 15.

The reprint data 120 is reprint data transmitted corresponding to a requested number of sheets or copies when the user requests the printer 102 to reprint a plurality of sheets (copies) using the copy quantity setting key 22.

The print job request (“Print-Job Request”) may be replaced with a URI print operation (“Print-Uniform Resource Identifier Operation). In this case, the transmission of the print data and the reprint data directly from the host 101 to the printer 102 is replaced with such an operation that the printer 102 receives data from a URI instructed by the host 101 and prints the received data. The print data that should be printed is stored in this URI in advance.

In the case where the printer 102 receives reprint data according to the URI, the host 101 may detect the memory capacity of the printer 102 in advance, divide the reprint data into data amounts each storable in the memory, and store the divided data into the URI.

In another exemplary embodiment, the printer side divides the reprint data into data amounts each storable into the memory according to the capacity of the reprint memory of the printer 102, and stores the divided data into the URI in advance. Then, the printer 102 starts printing the divided reprint data upon detection of a user's reprint instruction at the printer 102 or the host 101. Then, the printer 102 may sequentially receive the divided reprint data stored in advance from the URI according to the capacity of the reprint memory of the printer 102.

FIG. 17 illustrates how a host 201 transmits a print job to a printer 202 according to XML Paper Specification (XPS).

The system configuration corresponds to the configuration illustrated in FIG. 1. The host 202 is realized by any of the hosts 2 and 4, and the another host 6, and the printer 202 is realized by the printer 1.

An XPS printer driver is installed in the host 201 illustrated in FIG. 17, and the communication and processing illustrated in FIG. 17 are realized by cooperation between the XPS printer driver and the printer 202.

The host 201 is embodied by, for example, a PC or a mobile terminal. The printer 202 prints data on a medium such as paper in response to an instruction from the host 201.

A Print Capability document 203 is information for notifying the host 201 about, for example, the capability and function of the printer 202 such as the capacity of the reprint memory. A Print Ticket 204 is transmitted for notifying the printer 202 of information for printing such as a page setting, a print instruction about, for example, one-sided printing or two-sided printing, a specification of a paper feed stage, and a print quality. In the present exemplary embodiment, the Print Ticket 204 is transmitted for notifying the printer 202 of candidates settable with the printer driver.

A selected setting 205 is information for notifying the printer 202 of candidates that should be set for printing by the printer 202. An Updated Print Capability document 206 is information by which the printer 202 notifies the host 201 about, for example, the capability and function of the printer 202, which are updated in response to the selected setting 205.

A Print Ticket 207 is transmitted for notifying the printer 202 about candidates of, for example, conditions for actually printing print data based on the information of the Updated Print Capability document 206. A Modified selected setting 208 is information for notifying the printer 202 about candidates of modified settings for printing.

A Validated Print Capability document 209 is information for notifying valid settings among the contents of the print ticket notified by the Print Ticket 207. A Validated Print Ticket document 210 notifies the printer 202 of information to be actually printed by the printer 202 based on the Validated Print Capability document 209.

A Modified selected setting 211 is information for notifying the printer 202 of setting information valid at the time of printing. A Print JOB 212 is information of a job causing the printer 202 to print data.

A Fixed Document 213 is information for causing the printer 202 to print data. A Document structure 214 is information regarding a structure of a document to be printed by the printer 202.

A Fixed page 215 is information of a page to be printed by the printer 202.

A Thumbnail 216 is a thumbnail of an image of a page to be printed. An Image 217 is information of an image of a page to be printed.

A Font 218 is information regarding a font in a page to be printed. A process 219 indicates how the host 201 transmits a request to acquire the Print Capability document 203 from the printer 202.

A process 220 “GET PRINT CAPABILITY DOCUMENT” indicates how the host 201 acquires the Print Capability document 203 from the printer 202. A process 221 “PROVIDE PRINT TICKET” indicates how the host 201 transmits the Print Ticket 204 to the printer 202.

A process 222 “OBTAIN UPDATED PRINT CAPABILITY DOCUMENT” indicates how the host 201 acquires the Updated Print Capability document 206 from the printer 202. A process 223 “PROVIDE PRINT TICKET” indicates how the host 201 transmits the Print Ticket 207 to the printer 202.

A process 224 “OBTAIN VALIDATED PRINT CAPABILITY DOCUMENT” indicates how the printer 202 transmits the Validated Print Capability document 209 to the host 201. A process 225 “PROVIDE VALIDATED PRINT TICKET” indicates how the host 201 transmits the Validated Print Ticket document 210 to the printer 202.

A process 226 “SEND DATA” indicates how the host 201 transmits the Fixed Document 213 to the printer 202.

The printer 202 notifies the host 201 about the capacity of the reprint memory of the printer 202 by the Print Capability document. For example, the Print Capability document is used to notify the host 201 of information indicating, for example, that the memory capacity of the printer 202 is 64 megabytes, and 30 megabytes of 64 megabytes can be allocated for print processing.

The limitation information of the memory capacity of the printer 202 may be notified from the printer 202 to the host 201. Alternatively, the host 201 may recognize the printer capability by requesting the limitation information of the memory capacity to the printer 202 using a printer ID.

The printing system may be configured in such a manner that information of a document or page to be printed in the Fixed Document 213 is directly transmitted from the host 201 to the printer 202, or may be configured in such a manner that the host 201 notifies the printer 202 of a URI storing the Fixed Document 213, and the printer 202 receives the Fixed Document 213 using the URI.

A URI at the host 201 may be specified as the URI of the storage area storing the Fixed Document 213. Alternatively, in a case where the Fixed Document 213 is stored in another server, a URI indicating the other server may be specified as the URI of the storage area storing the Fixe Document 213.

The Print Ticket is specified for a job-level layer, a document-level layer, and a page-level layer separately.

When the host 201 transmits data information for reprinting, the host 201 may transmit reprint data of a job level or a document level, or may transmit reprint data page by page.

In a case where reprint data is transmitted in this configuration, first, the host 201 transmits the Fixed Document 213 as print data in the signal exchanges according to the above-described processes 219 to 226.

After that, the host 201 divides the Fixed Document 213 into data pieces each having a size storable into the reprint memory of the printer 202, and transmits the divided Fixed Document 213 to the printer 202. Then, when the host 201 or the printer 202 detects a reprint instruction from a user, the printer 202 prints the divided Fixed Document 213, and the host 201 transmits the remaining Fixe Document 213 subsequent to the divided Fixed Document 213 to the printer 202 according to the availability of the reprint memory.

In a case where there is a request to reprint a plurality of sheets (copies) from the user via the copy quantity setting key 22, the host 201 transmits the Fixed Document 213 or the divided Fixed Document 213 capable of achieving printing of the specified number of sheets or copies, to the printer 202.

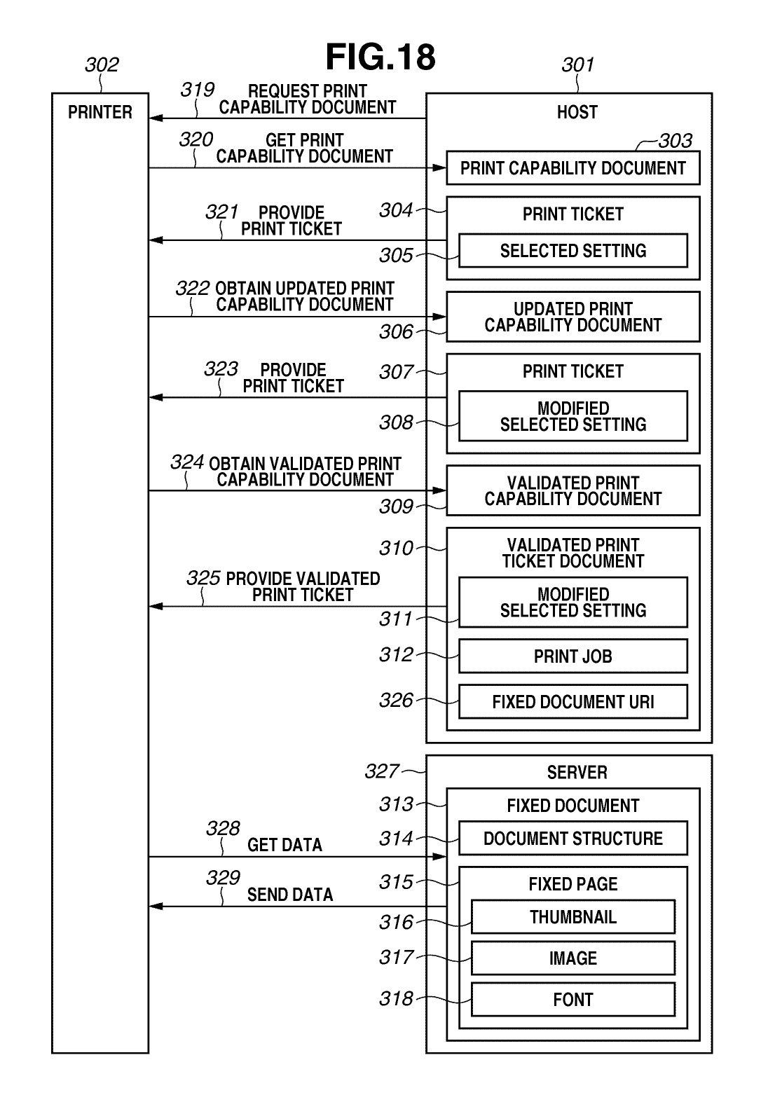

FIG. 18 illustrates how a host 301 transmits a print job to a printer 302 using a print ticket of XPS in a similar manner to the procedure illustrated in FIG. 17. A difference from the procedure illustrated in FIG. 17 is that a Fixed Document 313 is stored in a server 327.

Processes and components 301 to 325 are similar to the processes and components 201 to 225 illustrated in FIG. 17. A Fixed Document URI 326 is URI information indicating an area storing an image to be printed. The server 327 is a server that stores in advance the Fixed Document 313 to be printed.

The printer 302 requests the Fixed Document 313 using the URI information of the Fixed Document URI 326 by the process 328 “GET DATA”, and acquires the Fixed Document 313 as data to be printed by the process 329 “SEND DATA”.

According to the above-described configuration, the printer 302 can acquire the print data or the reprint data described above with reference to FIG. 17 from the server 327, and print the acquired data.

The printer 302 acquires the Fixed Document 313 as print data according to the URI, and prints the acquired data.

The host 301 may divide the Fixed Document 313 to generate reprint data, and store the divided reprint data into the server 327. Then, after printing the print data, the printer 302 receives the reprint data in advance by an amount storable in the memory of the printer 302 according to the capacity of the reprint memory of the printer 302, and stores the received data into the memory.

Then, upon issuance of a reprint instruction from the printer 302 or the host 301, the printer 302 may print the stored data, and receive the reprint data subsequent to the stored data from the URI according to the availability of the memory.

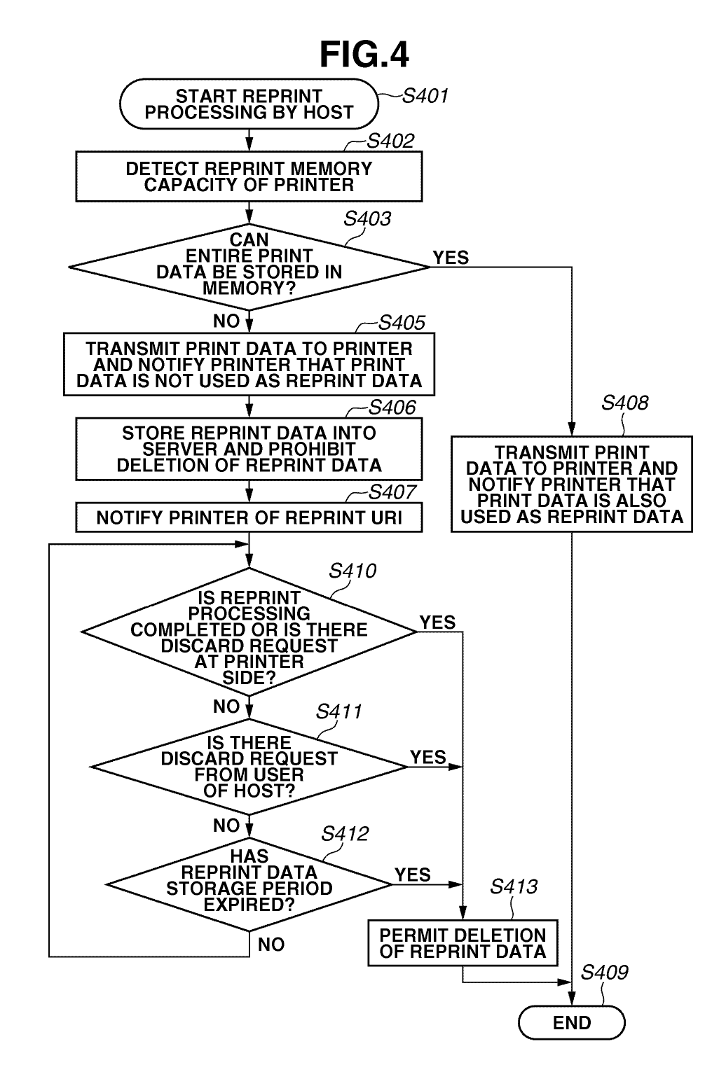

A second exemplary embodiment will be described now with reference to the flowchart illustrated in FIG. 4. FIG. 4 illustrates an example of an operation of the host side that stores undivided reprint data into the server 5 as reprint data. A difference from the operation illustrated in FIG. 2 is that step S406 and the steps subsequent thereto are different from step S6 and the steps subsequent thereto illustrated in FIG. 2.

In step S406, the host stores print data into the server 5 as reprint data, and prohibits deletion of the reprint data.

In step S407, the host notifies the printer 1 about a URI of the server 5 for realizing reprint processing. In step S410, the host determines whether the reprint processing is completed at the printer 1 or there is a discard request of the reprint data at the printer 1.

In step S411, the host determines whether a user of the host has issued a discard request of the reprint data. In step S412, the host determines whether a reprint data storage period has expired.

In step S413, the host allows deletion of the reprint data. As a result, the reprint data in the server 5 is deleted.

According to the above-described configuration, if the print data can be entirely stored in the image memory 25 of the printer 1 (YES in step S403), the print data can be reprinted. On the other hand, if the print data cannot be entirely stored in the image memory 25 (NO in step S403), in step S406, the host transmits the print data to the server 5 in the network 3 as reprint data. In step S407, the host or the server 5 notifies the printer 1 of the URI into which the reprint data is stored. Then, at the time of reprinting, the printer 1 receives the reprint data from the notified URI according to the availability of the image memory 25 of the printer 1, and prints the received data.

Therefore, the present exemplary embodiment can bring about an effect of a reduction in a load to the host by using the memory 37 of the server 5 instead of using the image memory 34 of the host 2 or 4 during reprint processing.

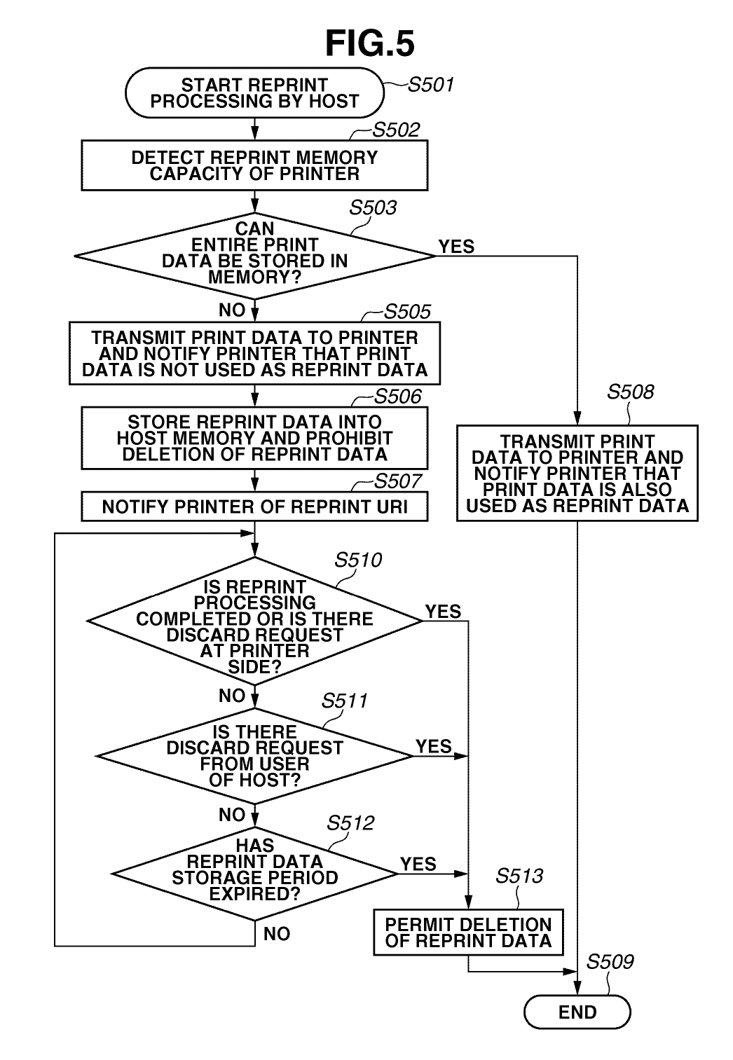

A third exemplary embodiment will be described with reference to a flowchart illustrated in FIG. 5.

FIG. 5 illustrates an example of an operation of the host side that stores undivided print data into the memory 34 of the host as reprint data. A different from the operation illustrated in FIG. 4 is that, in the operation illustrated in FIG. 4, reprint data is stored in the server 5 in step S406, while in the operation illustrated in FIG. 5, reprint data is stored in the memory 34 in the host in step S506.

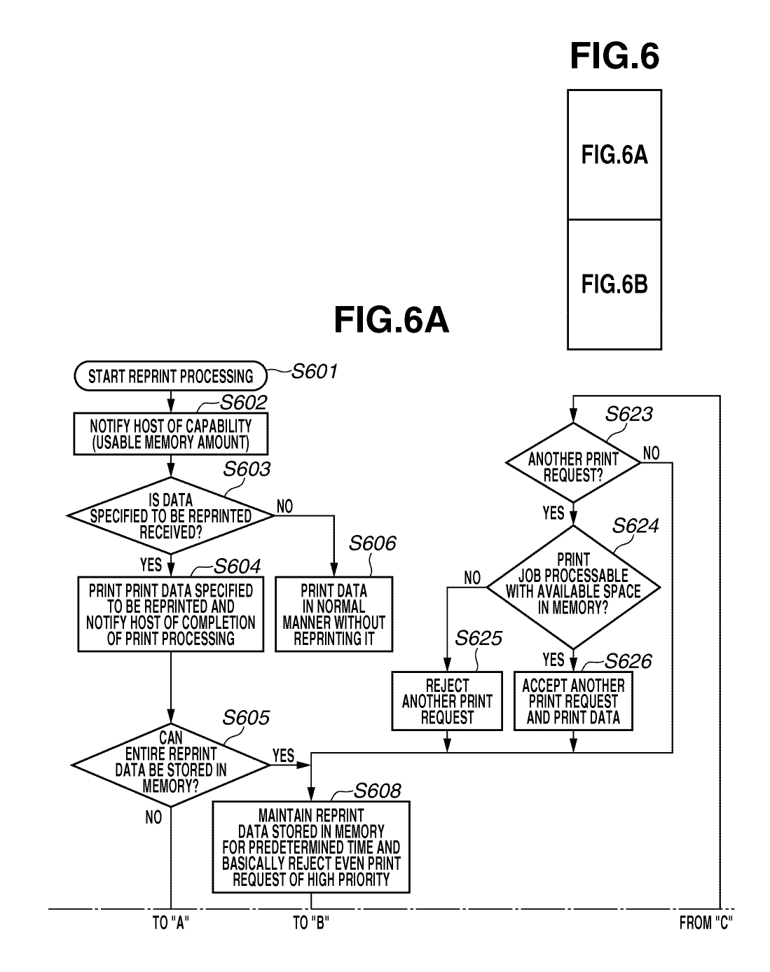

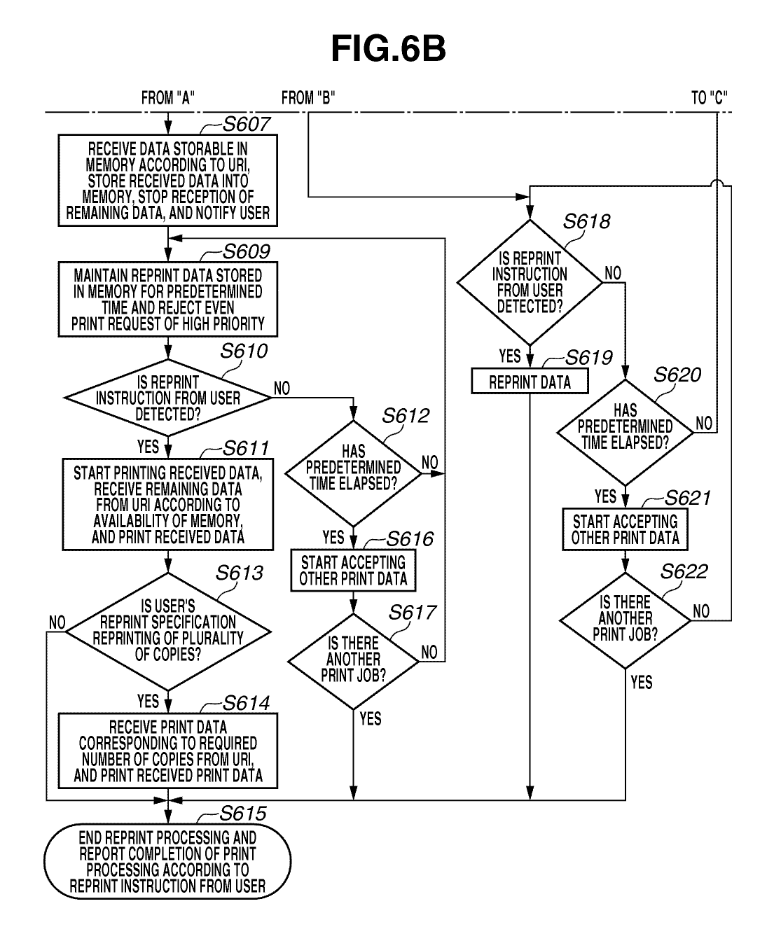

FIG. 6 (6A+6B) illustrates an example of an operation of the printer 1 that receives undivided data from a URI of the server 5 or the host. A difference from the operation illustrated in FIG. 3 is that, in the operation illustrated in FIG. 3, the printer 1 receives the divided data from the host in steps S307 and S314, while in the operation illustrated in FIG. 6, the printer 1 itself actively determines the capacity of the reprint memory in steps S607 and S611.

Then, in the operation illustrated in FIG. 6, the printer 1 receives the reprint data corresponding to the capacity of the reprint memory according to the URI notified from the host or the server 5. Further, in the operation illustrated in FIG. 3, in step S314, the printer 1 receives data from the host. On the other hand, in the operation illustrated in FIG. 6, in step S614, the printer 1 receives the data from the notified URI.

According to the above-described configuration, if the print data can be entirely stored in the image memory 25 of the printer 1 (YES in step S503), the print data can be reprinted. On the other hand, if the print data cannot be entirely stored in the image memory 25 (NO in step S503), in step S506, the print data is stored in the image memory 34 in the host as reprint data. At the time of reprinting, in step S507, the printer 1 receives the reprint data from the URI notified from the host according to the availability of the image memory 25 of the printer 1, and prints the received data.

In this way, the printer 1 actively receives the data from the memory 34 of the host according to the URI, whereby it is possible to reduce a load to the host during reprint processing without requiring the host to control timing of transmission of data while detecting the state of the printer 1.

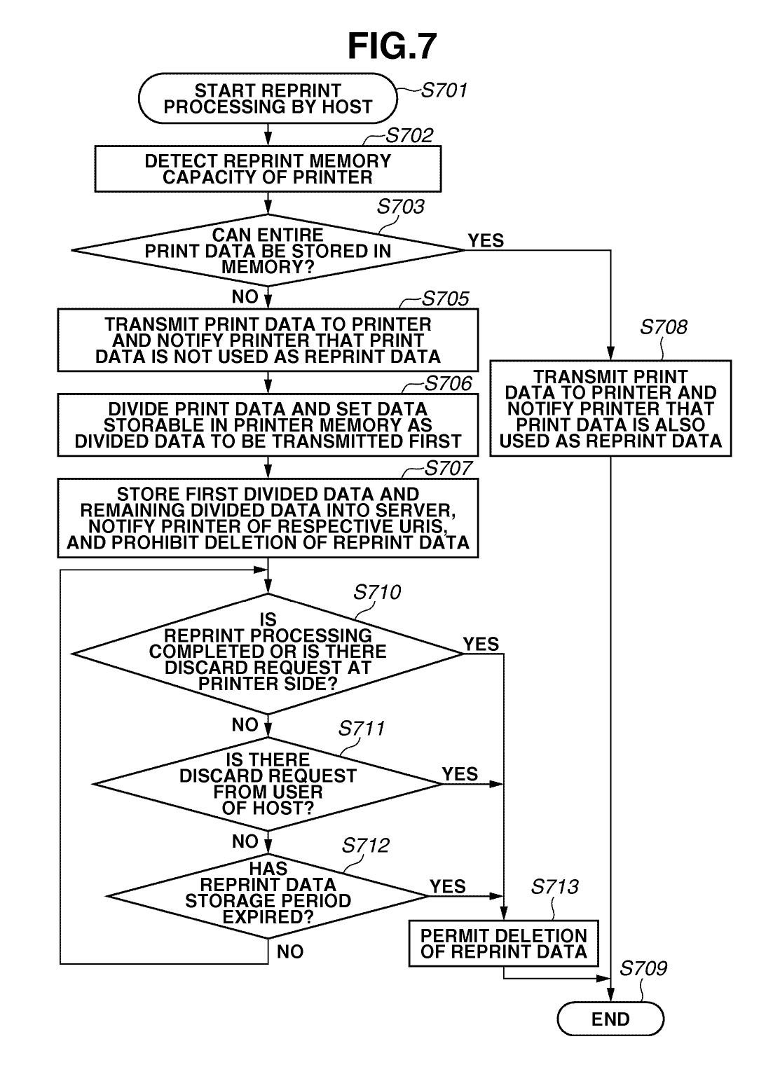

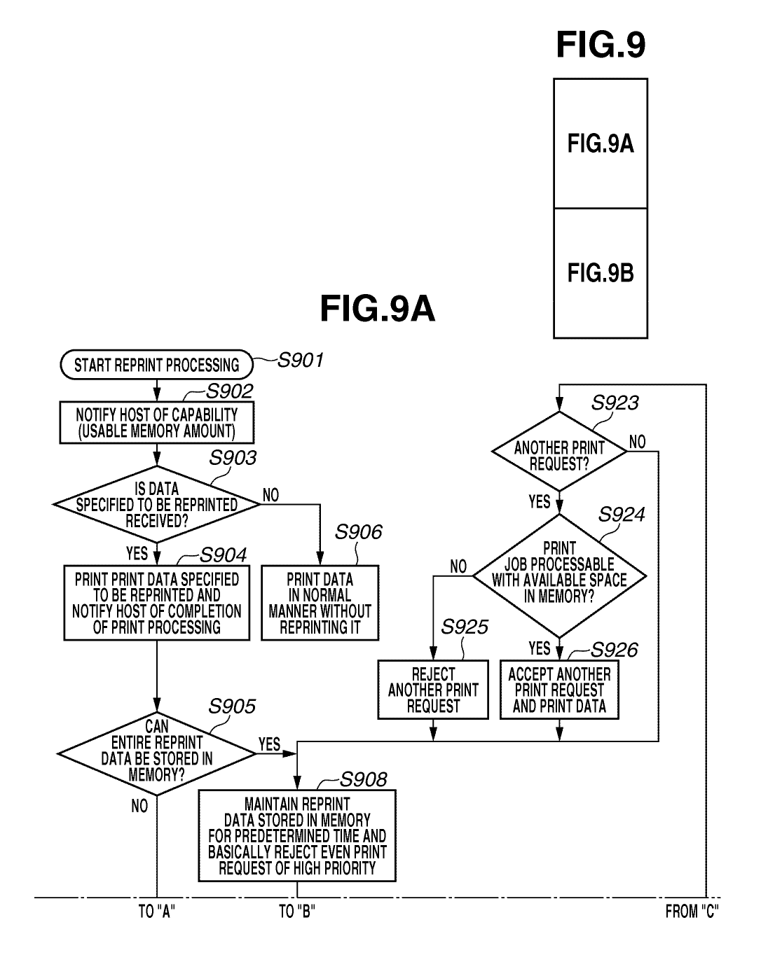

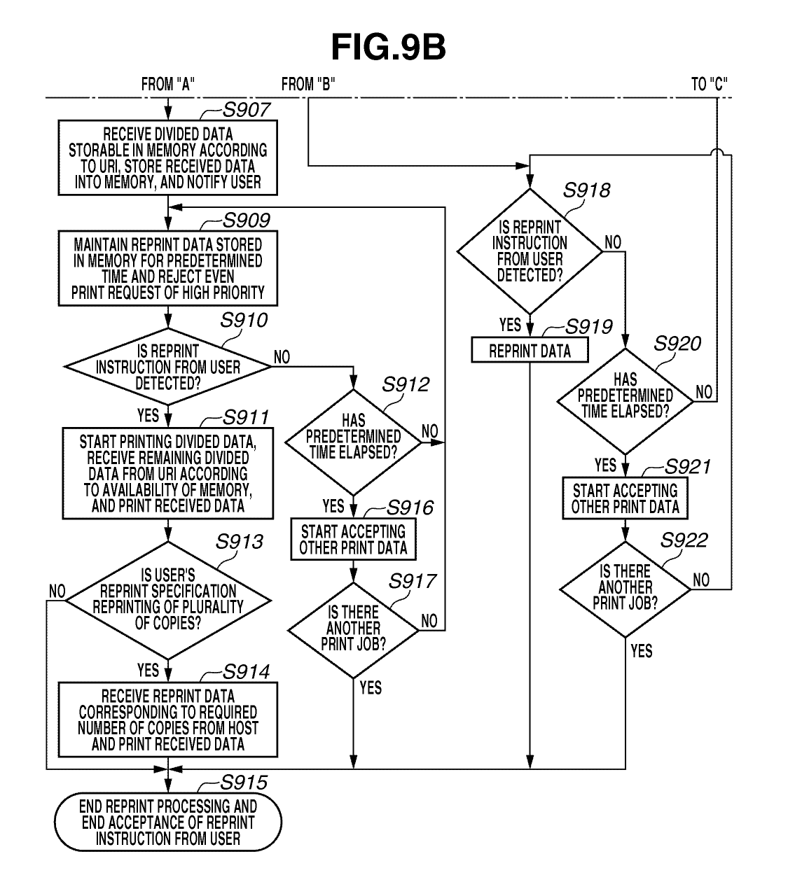

In a fourth exemplary embodiment, the host operates according to a flowchart illustrated in FIG. 7, and the printer 1 operates according to a flowchart illustrated in FIG. 9. FIG. 7 illustrates an example of an operation of the host side that divides print data and stores the reprint data into the server 5.

A difference from the operation illustrated in FIG. 4 is that, in the operation illustrated in FIG. 4, the host stores undivided print data into the server 5 and notifies the printer 1 of the URI in steps S406 and S407, while in the operation illustrated in FIG. 7, the host checks the capacity of the reprint memory of the printer 1 in steps S706 and S707. Then, the host divides print data, stores data of an amount storable into the reprint memory of the printer 1 into the server 5 as first divided data together with the remaining divided data, and notifies the printer 1 about the URIs of the respective data pieces.

FIG. 9 illustrates an example of an operation of the printer 1 that receives divided data from the URI of the server 5 or the host. A difference from the operation illustrated in FIG. 6 is that, in the operation illustrated in FIG. 6, the printer 1 receives data of an amount storable into the memory in steps S607 and S611, while in the operation illustrated in FIG. 9, the printer 1 receives data of an amount storable into the memory of the printer 1, which is divided by the host side, according to the URI in steps S907 and S911.

If the print data can be entirely stored in the image memory 25 of the printer 1 (YES in step S905), the print data can be reprinted.

The fourth exemplary embodiment functions according to the following processing. If the print data cannot be entirely stored in the image memory 25 (NO in step S703), in step S706, the host divides data so as to be storable into the capacity of the reprint memory. In step S707, the host transmits the divided data to the server 5 in the network 3.

At the time of reprinting, in step S907, the printer 1 stores the divided reprint data into the image memory 25 of the printer 1 according to the URI notified from the host or the server 5. In step S910, the printer 1 determines whether the printer 1 has detected a reprint start instruction from the printer 1 or the host. In step S911, according to the reprint start instruction, the printer 1 prints the divided data. In step S707, the host transmits the remaining divided data to the server 5 in the network 3. In step S911, after the printer 1 prints the first divided data according to the URI notified of from the host or the server 5, the printer 1 receives the remaining divided data according to the URI of the remaining divided data, and prints the received data.

In a similar manner to the third exemplary embodiment, the printer 1 actively receives the data from the memory of the host, whereby it is possible to reduce such a load that the host should control timing of data transmission while detecting the state of the printer 1. A difference from the third exemplary embodiment is that the fourth exemplary embodiment can bring about such an effect that the host divides the print data in advance, so that the printer 1 can process the divided data without monitoring the capacity of the image memory 25 in the printer 1, thereby reducing a load required to check the memory capacity of the printer 1.

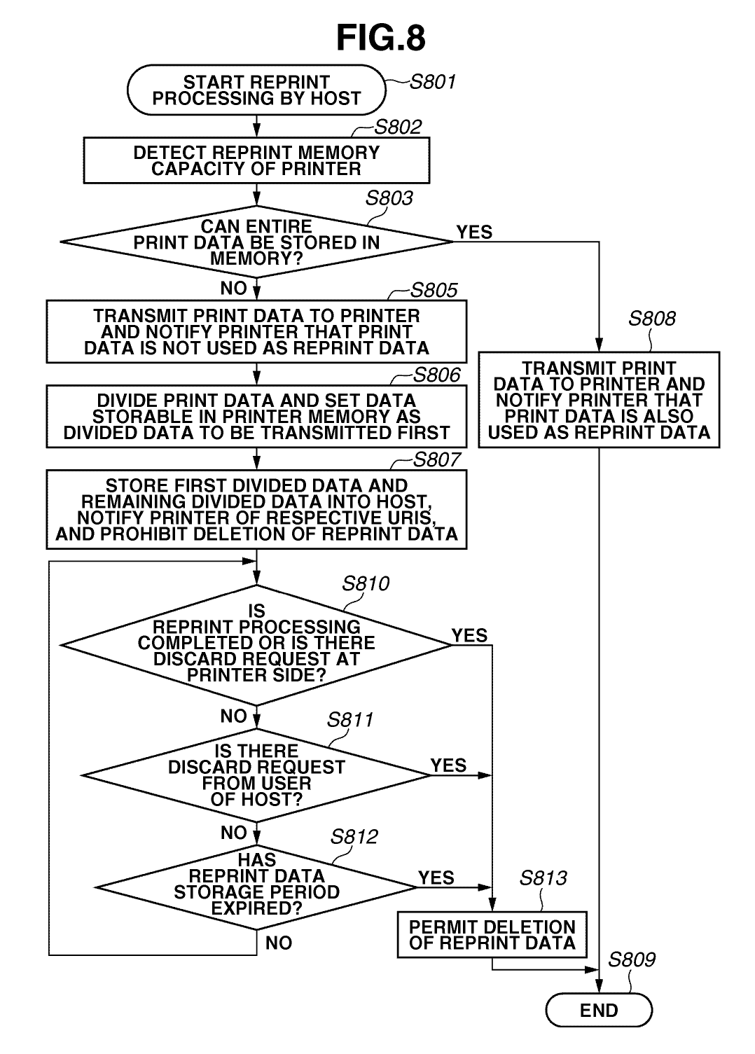

In a fifth exemplary embodiment, the host operates according to a flowchart illustrated in FIG. 8. FIG. 8 illustrates an example of an operation of the host side that stores divided data into the memory 34 in the host. The printer 1 operates according to the flowchart illustrated in FIG. 9. A difference from the operation illustrated in FIG. 7 is that, in the operation illustrated in FIG. 7, the host stores data into the server 5 in step S707, while in the operation illustrated in FIG. 8, the host stores data into the memory 34 in the host in step S807.

The difference from the fourth exemplary embodiment is that the host stores data into the memory 34 in the host, instead of storing data into the server 5. According to this configuration, the fifth exemplary embodiment can prevent data from being deleted or altered, or being viewed by an unauthorized person from another host (for example, the host 6), bringing about an effect of ensuring security. Data is stored in the memory 34 in the host, so high reliability of the data can be maintained.

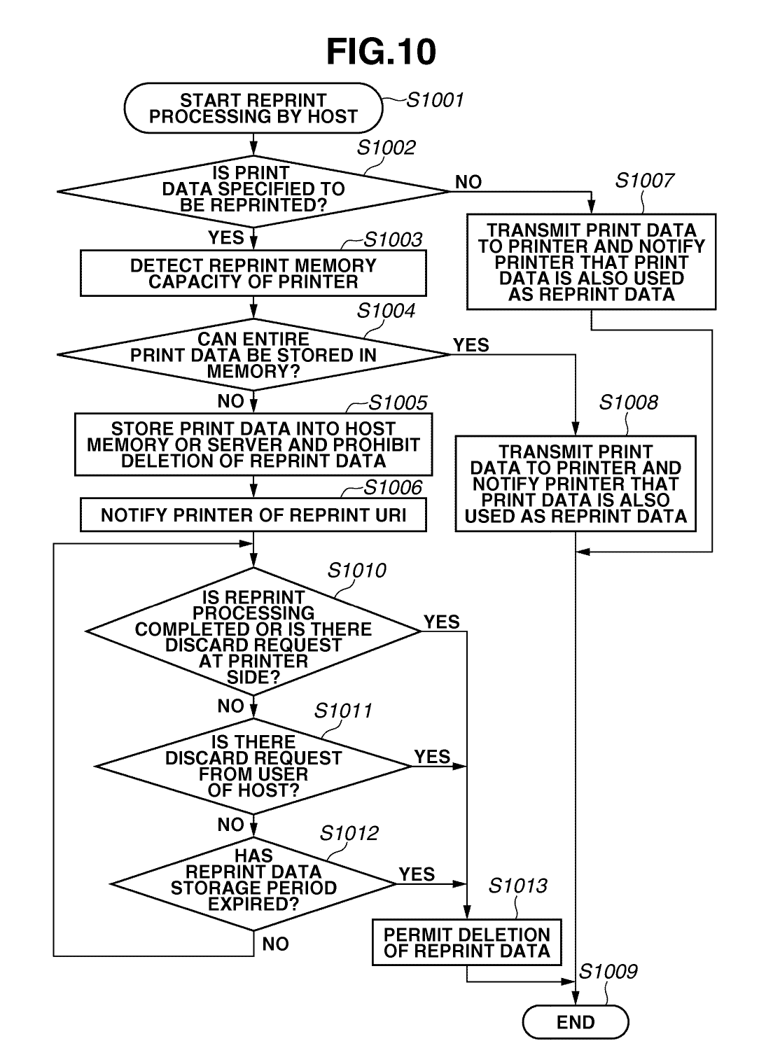

A sixth exemplary embodiment is an exemplary embodiment that operates according flowcharts illustrated in FIGS. 6 and 10. FIG. 10 illustrates an example of an operation of the host that allocates a memory resource of the host or the server 5 in a case where print data cannot be entirely stored in the memory 25 of the printer 1. In a case where print data cannot be entirely stored in the memory 25 of the printer 1, a resource of the server 5 or the host is allocated thereto, and reprint data stored in the host or the server 5 is prohibited from being deleted for a predetermined time even after printing.

In the operation illustrated in FIG. 10, steps S802 to S808 illustrated in FIG. 8 are replaced with steps S1002 to S1008. In step S1002, the host determines whether print data is specified to be reprinted. In step S1003, the host detects the capacity of the reprint memory of the printer 1.

In step S1004, the host determines whether reprint data can be entirely stored in the image memory 25. In step S1005, the host stores the print data into the host memory or the server 5, and prohibits deletion of the reprint data.

In step S1006, the host notifies the printer 1 of a print URI. In step S1007, the host transmits the print data to the printer 1, and notifies the printer 1 that the print data is not used as reprint data.

In step S1008, the host transmits the print data to the printer 1, and notifies the printer 1 that the print data is also used as reprint data.

According to the above-described configuration, the host does not distinguish the reprint data and the print data, and selects the transmission destination thereof, i.e., determines whether the host directly transmits the data to the printer 1 or stores the data into the host or the server 5, whereby the sixth exemplary embodiment can bring about an effect of simplification of the processing of the host.

In a case where the print data can be entirely stored in the image memory 25 of the printer 1, the host can simplify the subsequent processing by setting the print data so as to be also usable as reprint data. On the other hand, in a case where print data cannot be entirely stored in the image memory 25 of the printer 1, the host can simplify the subsequent processing by storing the data in the host or the server 5 and causing the printer 1 to actively receive the data.

According to the above-described configuration, the host checks the capacity of the image memory 25 of the printer 1. If the host determines that the print data can be entirely stored in the image memory 25 (YES in step S1004), in step S1008, the host directly transmits the print data to the printer 1 and allows the print data to be used for printing and reprinting. If the host determines that the print data cannot be entirely stored in the image memory 25 (NO in step S1004), in step S1005, the host stores the print data in the image memory 34 in the host or the server 5 in the network 3.

Then, in step S1006, the host or the server 5 notifies the printer 1 of the URI for printing the stored print job. The printer 1 prints the print data according to the URI. After printing the print data, in step S607, the printer 1 receives data of an amount storable in the image memory 25 from the URI and stores the received data in advance.

In step S611, in response to a reprint instruction from the host or the printer 1, the printer 1 sequentially prints the stored data, and sequentially receives image data of the print job from the URI according to the availability of the image memory 25, thereby reprinting the data.

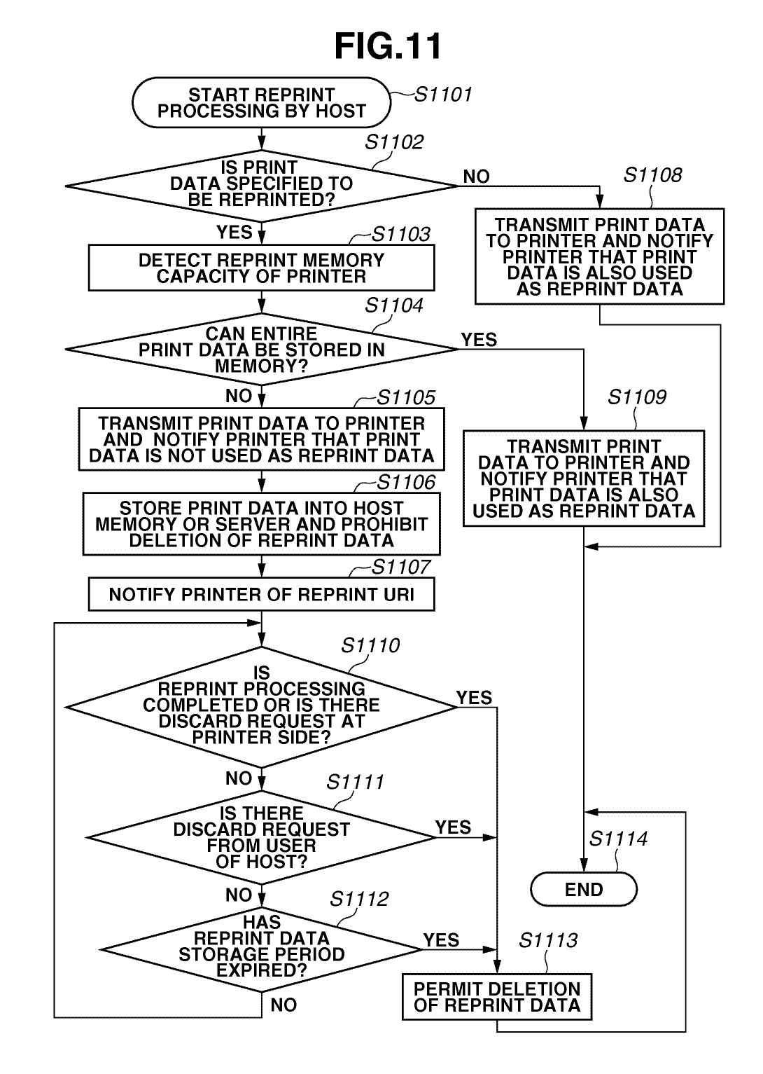

A seventh exemplary embodiment operates according to a flowchart illustrated in FIG. 11.

FIG. 11 illustrates an example of an operation of the host that allocates a memory resource of the host or the server 5 in a case where print data cannot be entirely stored in the image memory 25 of the printer 1. According to this flowchart, in a case where print data cannot be entirely stored in the image memory 25 of the printer 1, the host allocates a resource of the server 5 or the host. Further, the host prohibits deletion of reprint data stored in the host or the server 5 for a predetermined time even after printing. A difference from the operation illustrated in FIG. 10 is that step S1005 is replaced with steps S1105 and S1106.

In step S1105, the host transmits the print data to the printer 1, and notifies the printer 1 that the print data is not used as reprint data. In step S1106, the host stores the reprint data into the host memory or the server 5, and prohibits deletion of the reprint data.

According to the present exemplary embodiment, in a case where the print data cannot be entirely stored in the image memory 25, the host directly transmits the print data to the printer 1, whereby the transmission can be sped up since the host has a higher processing capability than the printer 1, thereby ensuring an improved FPOT. Further, the reprint data is stored in the image memory 34 or 37 of the host or the server 5, and the printer 1 actively receives the reprint data. As a result, the present exemplary embodiment can bring about an effect of a reduction in a load to the host.

According to the above-described configuration, the host checks the capacity of the image memory 25 of the printer 1. If the host determines that print data can be entirely stored in the image memory 25 (YES in step S1104), in step S1109, the host directly transmits the print data to the printer 1.

If the host determines that print data cannot be entirely stored in the image memory 25 (NO in step S1104), in step S1106, the host stores the print data in the image memory 34 in the host or the server 5 in the network 3 as reprint data after directly transmitting the print data to the printer 1.

Then, in step S1107, the host or the server 5 notifies the printer 1 of the URI for printing the stored reprint data.

After printing the print data, the printer 1 receives the reprint data of an amount storable in the image memory 25 from the URI and stores the received data in advance, and sequentially prints the stored data in response to a reprint instruction from the host or the printer 1. Then, the printer 1 sequentially receives the reprint data from the URI according to the availability of the image memory 25, and reprints the received data.

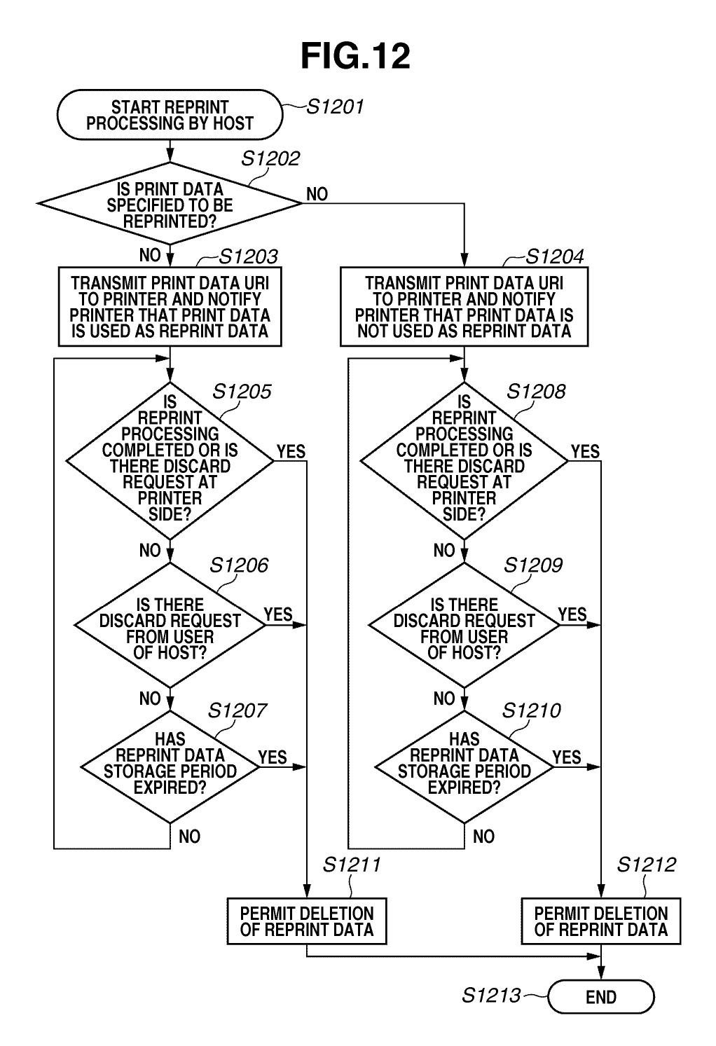

An eighth exemplary embodiment operates according to a flowchart illustrated in FIG. 12. FIG. 12 illustrates processing of the host side in a system in which the host notifies the printer 1 of a URI in which print data and reprint data are stored, and the printer 1 acquires the print data and the reprint data according to the URI.

A difference from the operation illustrated in FIG. 10 is that steps S1003 to S1008 are replaced with steps S1203, S1204, and S1208 to S1212. The condition for allowing deletion of print data is changed according to the reprint setting.

In step S1203, the host transmits a print data URI to the printer 1, and notifies the printer 1 that the print data is also used as reprint data. In step S1204, the host transmits a print data URI to the printer 1, and notifies the printer 1 that the print data is not used as reprint data.

In step S1208, the host detects whether print processing is completed at the printer side or there is a discard request at the printer side. In step S1209, the host detects whether there is a discard request from a host user. In step S1210, the host detect whether a print data storage period has expired.

In step S1211, the host allows deletion of the print data. In step S1212, the host allows deletion of the print data. The print data stored in the memory 34 or 37 of the host or the server 5 should be eventually deleted. Otherwise, the memory would be fully occupied and would be unable to allow execution of another operation. In the present exemplary embodiment, the timing of deleting the print data is controlled based on whether reprint setting is selected at the printer driver of the host, which is in charge of print settings of the print data.

If the reprint setting is selected by the print settings, in step S1205, the host determines whether a reprint operation is completed, based on which the reprint data is deleted. Alternatively, the data storage period (S1207) is determined according to a time in which a reprint operation is assumed to be completed, and the data is deleted upon the expiration of the data storage period. If the reprint setting is not selected, in step S1208, the host determines whether a print operation is completed, based on which the print data is deleted. Alternatively, according to the data storage period (S1210) in which a print operation is assumed to be completed, the data is deleted upon the expiration of the data storage period.

Setting the data storage period shorter than the storage period can prevent such a disadvantage that the memory would be inappropriately occupied, for example, in a case where the user forgets to reprint the data.

According to the above-described configuration, the present exemplary embodiment can bring about an effect of enabling efficient utilization of the memory resource of the host or the server 5 at the time of printing and reprinting.

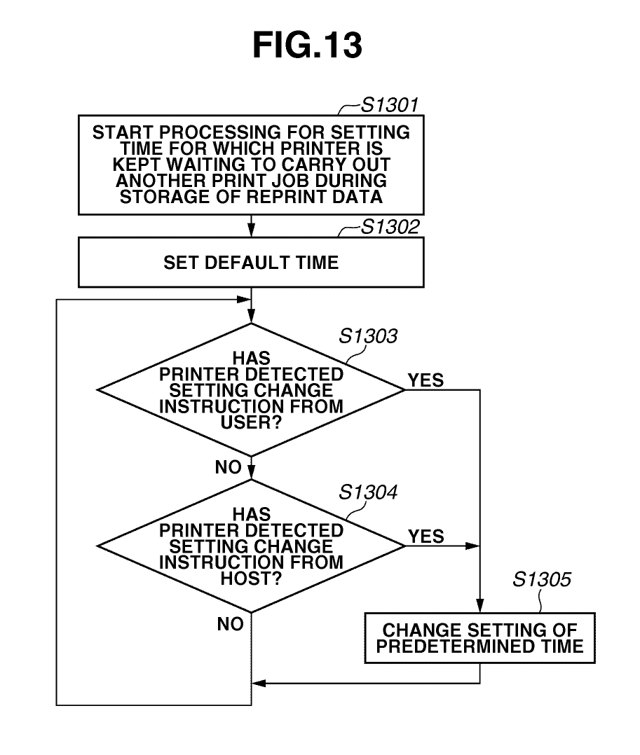

A ninth exemplary embodiment operates according to a flowchart illustrated in FIG. 13. FIG. 13 illustrates an operation in which the setting of the predetermined time used in step S309 or S609 can be changed with the key group 20 or according to an instruction from a user of the host.

In step S1301, the printer 1 starts processing for setting a time for which another print job is kept waiting at the printer 1 while reprint data is maintained stored in the printer 1. In step S1302, a default time is set. This default time is a time that a manufacturer of the printer 1 determines in advance.

In step S1303, the printer 1 determines whether the printer 1 has detected a setting change instruction from a user of the printer 1. In step S1304, the printer 1 determines whether the printer 1 has detected a setting change instruction from a user of the host. In step S1305, the printer 1 changes the setting of the predetermined time.

According to the present exemplary embodiment, the predetermined time used in step S309 or S609 can be set according to a user's intended purpose. For example, the present exemplary embodiment can be utilized in the following manner. That is, if a user will reprint data from a nearby PC, the user reduces the setting time in consideration of a travel time to reach the printer 1, while if a user will reprint data from a distant PC, the user increases the setting time.

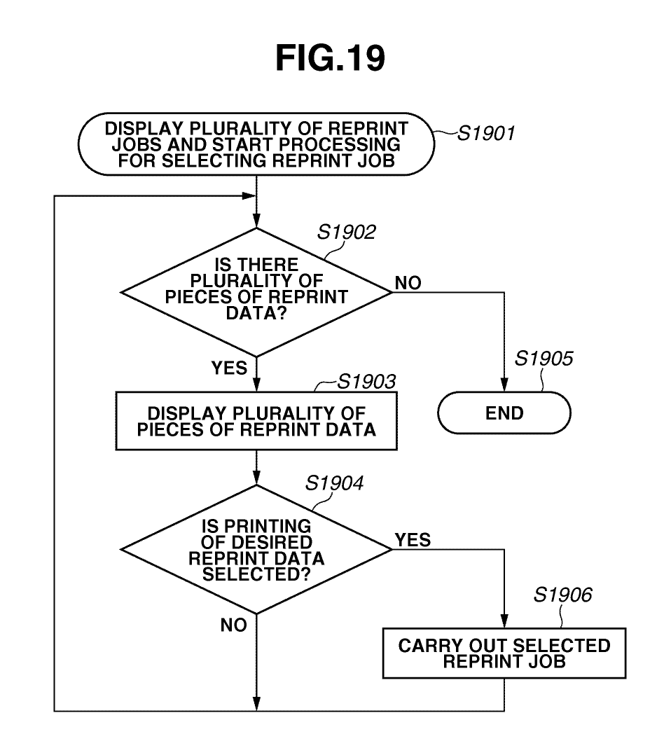

A tenth exemplary embodiment operates according to a flowchart illustrated in FIG. 19. FIG. 19 is a flowchart illustrating an operation of the printer 1 that, in a case where there is a plurality of print jobs, displays print jobs corresponding to the printer jobs thereof on the display unit 17 of the printer 1 to allow a user to select one of them.

In step S1901, the printer 1 starts processing for displaying a plurality of reprint jobs and allowing print job selection. In step S1902, the printer 1 determines whether there is a plurality of reprint data pieces. In step S1903, the printer 1 displays a plurality of desired reprint data pieces.

In step S1904, the printer 1 determines whether a user has selected printing of desired reprint data. In step S1905, the printer 1 ends the processing. In step S1906, the printer 1 carries out the selected reprint job.

According to the example illustrated in FIG. 19, if a plurality of reprint jobs is accepted by the printer 1 (YES in step S1902), in step S1903, the printer 1 displays accepted reprint jobs. Then, in step S1906, the printer 1 carries out the reprint job selected by the user among the accepted reprint data pieces.

According to the above-described configuration, in step S1903, the printer 1 displays that there is a plurality of reprint data pieces. In step S1906, the printer 1 prints the selected reprint data. Therefore, the present exemplary embodiment can bring about an effect of allowing a plurality of reprint jobs to be carried out.

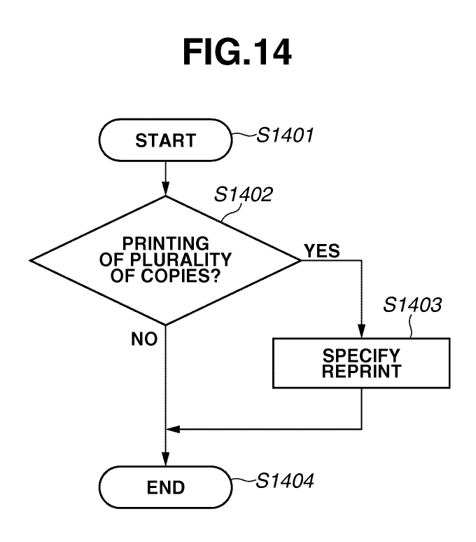

An eleventh exemplary embodiment operates according to a flowchart illustrated in FIG. 14. FIG. 14 illustrates an example of an operation of the host side that automatically specifies reprinting when a user specifies printing of a plurality of copies using the printer driver at the host side.

In step S1401, the host starts the processing. In step S1402, the host determines whether the number of copies that a user set using the printer driver is printing of a plurality of copies. In step S1403, the host specifies reprinting to this print job. In step S1404, the host ends the processing.

According to the above-described configuration, if the user instructs the printer 1 to print a plurality of copies using the printer driver of the host (YES in step S1402), in step S1403, the host automatically specifies reprinting.

As a result, the present exemplary embodiment can bring about such an effect that, when a user wants to print a plurality of copies, the printer 1 is automatically set to print one copy, and print the remaining copies after the user checks the print result in a similar manner to the first exemplary embodiment, thereby preventing the printer 1 from wastefully printing a plurality of copies that fails to meet user's expectation.

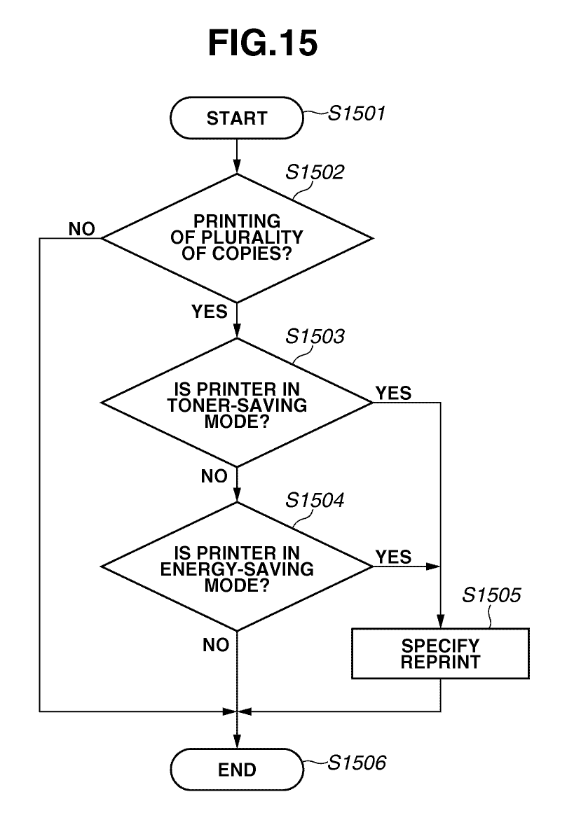

A twelfth exemplary embodiment operates according to the flowchart illustrated in FIG. 15.

FIG. 15 illustrates an example of an operation of the host side that sets a reprint (trial) mode when printing of a plurality of copies is specified at the host side and a toner saving mode or energy saving mode of the printer 1 is specified at the host or the printer 1.

In step S1501, the host starts the processing. In step S1502, the host determines whether printing of a plurality of copies is specified. In step S1503, the host determines whether the setting that a user selects by using the printer driver at the host is the toner saving mode.

In step S1504, the host determines whether the setting of the printer 1 is the energy saving mode. In step S1505, the host specifies reprinting to that print job. In step S1506, the host ends the processing.

The toner saving mode is a mode of saving a toner use amount by reducing a toner use amount compared to normal printing (for example, 50%). Use of this toner saving mode results in a reduction in the density of a print product. The toner saving mode may be called an ecology mode or a draft mode.

According to the above-described configuration, the present exemplary embodiment can bring about the following effect. When a user sets printing of a plurality of copies, this user may be a user who wants to print the plurality of copies in a normal manner instead of reprinting them, if the user does not prefer resource saving. It is highly likely that a user desires resource saving if the user specifies the toner saving mode. The present exemplary embodiment can automatically recognize a user who desires such resource saving, and automatically select the reprint function.

The scopes of the above-described exemplary embodiments encompass a processing method including storing a program enabling the configurations of one or more of the above-described exemplary embodiments to operate so as to realize the functions of the aforementioned one or more of the above-described exemplary embodiments into a storage medium, and causing a computer to read out the program stored in the storage medium as codes and execute them. Further, the storage medium storing the above-described program and even the program itself are also within the scopes of the above-described exemplary embodiments.

Examples of media usable as a storage medium (a computer readable medium) for one or more of the program and the image memory include a floppy (registered trademark) disk, a hard disk, an optical disk, a magneto-optical disk, a compact disk read only memory (CD-ROM), a magnetic tape, a non-volatile memory, and a read only memory.

Further, the scopes of the above-described exemplary embodiments encompass not only the case that the computer realizes the operations of the above-described exemplary embodiments by executing the program stored in the above-described storage medium alone, but also the case that the computer realizes the operations of the above-described exemplary embodiments by working on an operating system (OS) in cooperation with other software and/or a function of an expansion board.

Aspects of the present invention can be realized by a computer of a system or apparatus (or devices such as a CPU or a micro-processing unit (MPU) (which may also be referred to as a microprocessor)) that reads out and executes a program recorded on a memory device to perform the functions of one or more of the above-described embodiments, and by a method, the steps of which are performed by a computer of a system or apparatus by, for example, reading out and executing such a program recorded on a memory device to perform the functions of the above-described embodiments. System memory of the computer may be used for image memory or alternatively dedicated image memory may be provided. The program can be provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-277325 filed Dec. 19, 2011, which is hereby incorporated by reference herein in its entirety.

What is claimed is:

1. An image forming apparatus for use in an operating environment that includes an image memory, comprising:
a printing unit configured to print data;
a determining unit configured to determine whether all pages of the print data can be stored in the image memory as reprint data;
a storage unit configured to store data of a first page to an N-th page of the print data into the image memory in a case where the determining unit determines that all pages of the print data cannot be entirely stored in the image memory as the reprint data;
an accepting unit configured to accept a reprint start instruction; and
a receiving unit configured to receive data of an N+1-th page to a final page of the print data,
wherein the printing unit prints the stored data of the first page to the N-th page and the receiving unit receives the data of the N+1-th page to the final page to be printed by the printing unit in a case where the accepting unit accepts the reprint start instruction.

2. The image forming apparatus according to claim 1, wherein the print data is transmitted from a host, and the print data is set to be reprinted in a case where printing of a plurality of copies of the print data is specified at the host.

3. The image forming apparatus according to claim 1, wherein the receiving unit receives the data of the N+1-th page to the final page of the print data from a server.

4. An image forming method performed by an image forming apparatus provided with an image memory, the image forming method comprising:
printing print data;
determining whether all pages of the print data can be stored in the image memory as reprint data;
storing data of a first page to an N-th page of the print data into the image memory in a case where it is determined that all pages of the print data cannot be entirely stored in the image memory as the reprint data;
storing the data of the first page to the N-th page of the print data into the image memory;
accepting a reprint start instruction; and
receiving data of an N+1-th page to a final page of the print data,
wherein the image forming apparatus prints the stored data of the first page to the N-th page and the image forming apparatus receives the data of the N+1-th page to the final page to print the received data in response to accepting the reprint start instruction.

5. The image forming method according to claim 4, wherein the print data is transmitted from a host, and the print data is set to be reprinted in a case where printing of a plurality of copies of the print data is specified at the host.

6. The image forming method according to claim 4, wherein the data of the N+1-th page to the final page of the print data is received from a server.

7. A computer readable storage medium storing a program for causing a computer provided with an image memory to execute an image forming method, the image forming method comprising:
printing print data;
determining whether all pages of the print data can be stored in the image memory as reprint data;
storing data of a first page to an N-th page of the print data into the image memory in a case where it is determined that all pages of the print data cannot be entirely stored in the image memory as the reprint data;
storing the data of the first page to the N-th page of the print data into the image memory;
accepting a reprint start instruction; and
receiving data of an N+1-th page to a final page of the print data,
wherein the image forming apparatus prints the stored data of the first page to the N-th page according to the reprint start instruction, and the image forming apparatus receives the data of the N+1-th page to the final page to print the received data in response to accepting the reprint start instruction.
